(19) United States
(12) Patent Application Publication
(10) Pub. No.: US 2002/0133408 A1
(43) Pub. Date: Sep. 19, 2002

(54) Process and product for promoting a product

(76) Inventors: Jay S. Walker, Ridgefield, CT (US); Andrew S. Van Luchene, New York, NY (US); Dean P. Alderucci, Stamford, CT (US)

Correspondence Address: WALKER DIGITAL, FIVE HIGH RIDGE PARK, STAMFORD, CT, 06905, US

(21) Appl. No.: 10/100,565

(22) Filed: Mar. 15, 2002

Related U.S. Application Data
(60) Provisional application No. 60/276,198, filed on Mar. 15, 2001.

(51) Int. Cl. G06F 17/60

(52) U.S. Cl. 705/14

(57) ABSTRACT

Systems and methods are provided for enforcing brand loyalty. A controller receives from a customer an agreement to restrict purchases of at least one particular product. The controller also receives data representing purchases made by the customer. If it is verified that the customer has complied with the agreement to restrict purchases of the at least one particular product, then the customer is provided a benefit.

### CROSS-REFERENCE TO RELATED APPLICATIONS

This application claims the benefit of provisional patent application Serial No. 60/276,198, filed Mar. 15, 2001, entitled “SYSTEMS AND METHODS FOR ESTABLISHING AND REWARDING RECIPROCAL BRAND LOYALTY”, the content of which is incorporated by reference herein for all purposes.

### CROSS-REFERENCE TO RELATED APPLICATIONS

This application is related to the following co-pending U.S. patent applications:

U.S. patent application Ser. No. ______ , (attorney docket no. 00-109) entitled “METHOD AND APPARATUS FOR PROMOTING A PRODUCT”, filed concurrently herewith;

U.S. patent application Ser. No. ______ , (attorney docket no. 00-112) entitled “PROCESS AND PRODUCT FOR ENFORCING PURCHASE AGREEMENTS”, filed concurrently herewith;

U.S. patent application Ser. No. ______ , (attorney docket no. 00-113) entitled “METHOD AND APPARATUS FOR PRODUCT DISPLAY”, filed concurrently herewith;

U.S. patent application Ser. No. 09/609,598, entitled “SYSTEMS AND METHODS WHEREIN A BUYER PURCHASES PRODUCTS IN A PLURALITY OF PRODUCT CATEGORIES”, filed Jun. 29,2000;

U.S. patent application Ser. No. 08/889503, entitled “SYSTEMS AND METHODS WHEREIN A BUYER PURCHASES A PRODUCT AT A FIRST PRICE AND ACQUIRES THE PRODUCT FROM A MERCHANT THAT OFFERS THE PRODUCT FOR SALE AT A SECOND PRICE”, filed Jul. 8, 1997 and issued as U.S. Pat. No. 6,249,772 on Jun. 19, 2001;

U.S. patent application Ser. No. 09/591594, entitled “SYSTEMS AND METHODS WHEREIN A BUYER PURCHASES A PRODUCT AT A FIRST ASSOCIATED WITH A MERCHANT THAT OFFERS THE PRODUCT FOR SALE AT A SECOND PRICE”, filed Jun. 29, 2000;

U.S. patent application Ser. No. 09/348566, entitled “SETTLEMENT SYSTEMS AND METHODS WHEREIN A BUYER TAKES POSSESSION AT A RETAILER OF A PRODUCT PURCHASED USING A COMMUNICATION NETWORK”, filed Jul. 7, 1999;

U.S. patent application Ser. No. 09/388723, entitled “REDEMPTION SYSTEMS AND METHODS WHEREIN A BUYER TAKES POSSESSION AT A RETAILER OF A PRODUCT PURCHASED USING A COMMUNICATION NETWORK”, filed Sep. 2, 1999;

U.S. patent application Ser. No. 09/337906, entitled “PURCHASING SYSTEMS AND METHODS WHEREIN A BUYER TAKES POSSESSION AT A RETAILER OF A PRODUCT PURCHASED USING A COMMUNICATION NETWORK”, filed Jun. 22, 1999;

U.S. patent application Ser. No. 09/370291, entitled “SUPPLEMENTAL OFFERS WHEREIN A BUYER TAKES POSSESSION AT A RETAILER OF A PRIMARY PRODUCT PURCHASED THROUGH A PURCHASING SYSTEM”, filed Aug. 9, 1999;

U.S. patent application Ser. No. 09/412930, entitled “METHODS AND APPARATUS WHEREIN A BUYER ARRANGES TO PURCHASE A FIRST PRODUCT USING A COMMUNICATION NETWORK AND SUBSEQUENTLY TAKES POSSESSION OF A SUBSTITUTE PRODUCT AT A RETAILER”, filed Oct. 5, 1999; and

U.S. patent application Ser. No. 09/540035, entitled “RETAIL SYSTEM FOR SELLING PRODUCTS BASED ON A FLEXIBLE PRODUCT DESCRIPTION″”, filed Mar. 31, 2000.

The content of each of the above is incorporated by reference herein for all purposes.

### BACKGROUND OF THE INVENTION

A customer may purchase products at a retailer. Many times, customers are indifferent to certain types of products and consider those products readily substitutable for each other. Other products may be weakly preferred over other products.

Few systems exist for recognizing this information, and few systems exist for utilizing this information.

### BRIEF DESCRIPTION OF THE DRAWINGS

FIG. 1A is a block diagram of an embodiment of a system consistent with the present invention;

FIG. 1B is a block diagram of another embodiment of a system consistent with the present invention;

FIG. 1C is a block diagram of another embodiment of a system consistent with the present invention;

FIG. 2 is a block diagram of one embodiment of a controller;

FIG. 3 is a table illustrating an exemplary data structure of a customer database;

FIG. 4 is a table illustrating an exemplary data structure of a product database;

FIG. 5 is a table illustrating an exemplary data structure of a reciprocal intent database;

FIG. 6 is a table illustrating an exemplary data structure of an actual transaction database;

FIG. 7 is a flow diagram illustrating an exemplary process according to an embodiment of the present invention;

### DETAILED DESCRIPTION OF THE INVENTION

Applicants have recognized that, in some situations, it can be advantageous to enforce brand loyalty and reward customers for brand loyalty. For example, a customer may agree to purchase at least one product (from among several competing products) exclusively, and be rewarded for such agreement.

For example, a customer may establish an agreement to exclusively purchase one brand of cola from among several competing brands or manufacturers. In exchange, the customer may be entitled to a benefit, such as a discount, free product, etc. in exchange for the customer's promise of exclusivity.

The agreement may be made enforceable by way of the customer agreeing to forfeit any benefit to which he is entitled should the customer fail to purchase from within the limited branded grouping. Exclusivity compliance may be monitored via a computer-executable routine, performed against information relating to the consumer's purchases.

Using the beverage example above, a customer may agree to purchase only beverages produced by a certain bottler (e.g. Coca-Cola® Bottling Company) in exchange for a discount on each product purchased. Ensuring that the customer purchases only beverages produced by the bottler may be achieved by auditing information generated each time the customer makes a purchase. For example, a customer's frequent shopper card may function to index information representing products purchased by the customer. Should the information reveal that the customer has in fact not purchased at least one beverage produced by the bottler, the customer may forfeit any discount to which s/he was previously entitled.

According to other embodiments of the present system, if a customer is found to be in breach of their agreement, the value of any previously-provided benefit(s) may be recouped through the use of a financial account identifier of the customer (e.g. a credit or debit card number).

According to other embodiments of the present system, any benefit(s) to be provided to the customer in exchange for the customer agreeing to purchase exclusively from a given set of products.

Further embodiments of the present system may entail providing an “up-front” benefit in exchange for a customer promise to purchase exclusively from a given branded grouping. For example, a customer may be provided with a discount toward a first purchase of a specific product in exchange for the customer agreeing to purchase the product a number of times in the future, or over a given duration of time.

Furthermore, according to certain embodiments, the present system may be employed to monitor an individual customer's compliance across multiple merchants or types of merchants. For example, customer compliance may be monitored by auditing information representing purchases made by the customer. More specifically, the present system may function to track and record which products the customer has and has not purchased over a certain period of time, and to reward the customer accordingly.

According to an embodiment of the present invention, a product may be priced by way of receiving, from a customer, information defining one or more group(s) of comparable products the consumer is willing to purchase from, the information further including a price the customer is willing to pay. The buyer-defined price may be provided in exchange for individual products from within the group, or for the group itself.

For example, the on-line pricing system may transmit a redemption code to the customer device, entitling the customer to take delivery of one or more product(s) from a retailer local to the customer.

Upon taking delivery of the previously priced product(s), the customer device may communicate information related to the product(s) (e.g. one or more product identifier(s)) to the applicable retailer system. According to some embodiments of the present invention, rather than providing information related to the specific products having been taken delivery of, the customer or customer device may simply provide the previously received redemption code to the retailer system. A detailed discussion of manners in which a redemption code may be assigned, issued and redeemed, as well as other methods related to the process of establishing a price for products and then acquiring products from a retailer, is provided in the following:

U.S. patent application Ser. No. 09/609,598, entitled “SYSTEMS AND METHODS WHEREIN A BUYER PURCHASES PRODUCTS IN A PLURALITY OF PRODUCT CATEGORIES”, filed Jun. 29,2000;

U.S. patent application Ser. No. 08/889503, entitled “SYSTEMS AND METHODS WHEREIN A BUYER PURCHASES A PRODUCT AT A FIRST PRICE AND ACQUIRES THE PRODUCT FROM A MERCHANT THAT OFFERS THE PRODUCT FOR SALE AT A SECOND PRICE”, filed Jul. 8, 1997 and issued as U.S. Pat. No. 6,249,772 on Jun. 19, 2001;

U.S. patent application Ser. No. 09/591594, entitled “SYSTEMS AND METHODS WHEREIN A BUYER PURCHASES A PRODUCT AT A FIRST PRICE AND PHYSICALLY ACQUIRES THE PRODUCT AT A LOCATION ASSOCIATED WITH A MERCHANT THAT OFFERS THE PRODUCT FOR SALE AT A SECOND PRICE”, filed Jun. 29, 2000;

U.S. patent application Ser. No. 09/348566, entitled “SETTLEMENT SYSTEMS AND METHODS WHEREIN A BUYER TAKES POSSESSION AT A RETAILER OF A PRODUCT PURCHASED USING A COMMUNICATION NETWORK”, filed Jul. 7, 1999;

U.S. patent application Ser. No. 09/388723, entitled “REDEMPTION SYSTEMS AND METHODS WHEREIN A BUYER TAKES POSSESSION AT A RETAILER OF A PRODUCT PURCHASED USING A COMMUNICATION NETWORK”, filed Sep. 2, 1999;

U.S. patent application Ser. No. 09/337906, entitled “PURCHASING SYSTEMS AND METHODS WHEREIN A BUYER TAKES POSSESSION AT A RETAILER OF A PRODUCT PURCHASED USING A COMMUNICATION NETWORK”, filed Jun. 22, 1999;

U.S. patent application Ser. No. 09/370291, entitled “SUPPLEMENTAL OFFERS WHEREIN A BUYER TAKES POSSESSION AT A RETAILER OF A PRIMARY PRODUCT PURCHASED THROUGH A PURCHASING SYSTEM”, filed Aug. 9, 1999;

U.S. patent application Ser. No. 09/412930, entitled “METHODS AND APPARATUS WHEREIN A BUYER ARRANGES TO PURCHASE A FIRST PRODUCT USING A COMMUNICATION NETWORK AND SUBSEQUENTLY TAKES POSSESSION OF A SUBSTITUTE PRODUCT AT A RETAILER”, filed Oct. 5, 1999; and

U.S. patent application Ser. No. 09/540035, entitled “RETAIL SYSTEM FOR SELLING PRODUCTS BASED ON A FLEXIBLE PRODUCT DESCRIPTION″”, filed Mar. 31, 2000.

According to another embodiment of the invention, products may be priced by way of receiving, from a consumer, information defining one or more types or categories of comparable products the consumer is willing to purchase from. Thereafter, the system may select one or more products from the group.

These and other embodiments are described herein.

### SYSTEM

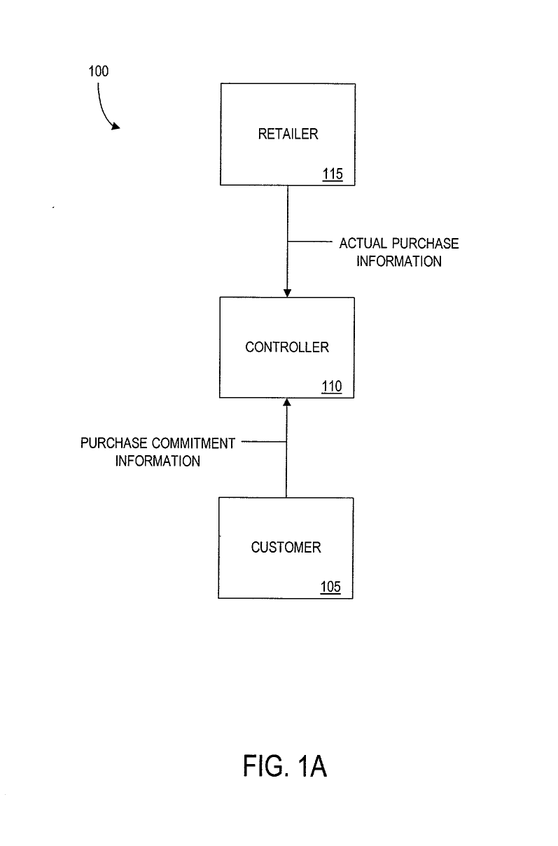

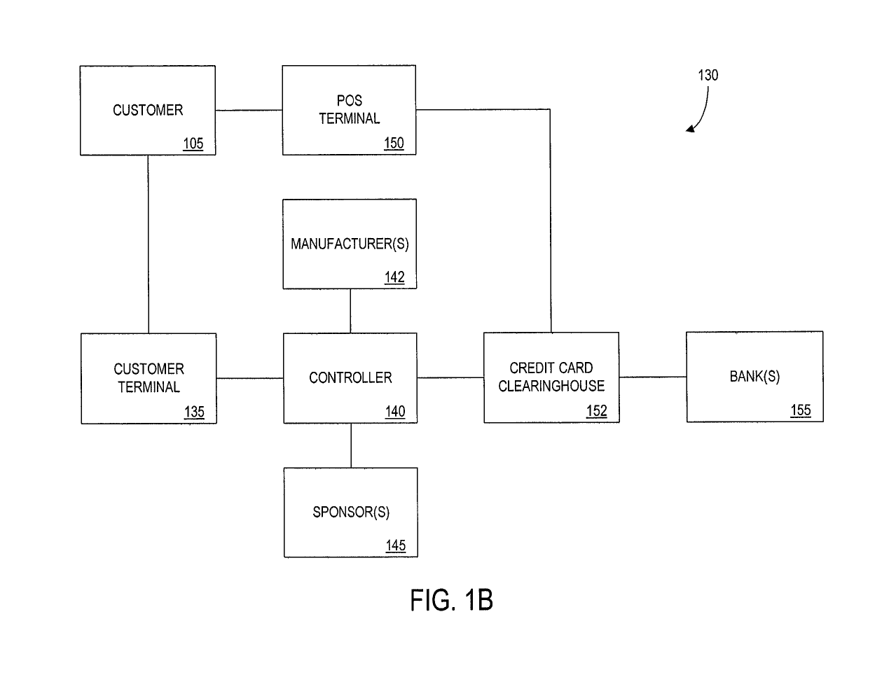

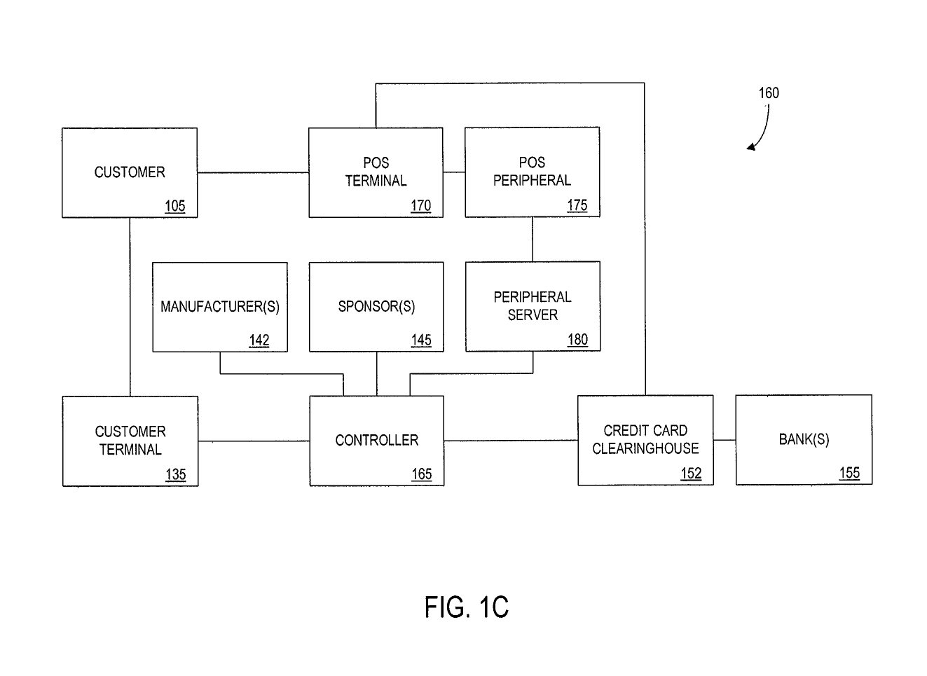

Referring now to FIG. 1, an apparatus 100 according to an embodiment of the present invention includes a controller 110 that is in communication with one or more retailers 115 via a network such as the Internet (wired and/or wirelessly), via another network protocol, or via other means for communication as would be understood by those of ordinary skill in the art. Although only one retailer 115 is depicted in FIG. 1A, any number of retailers may be in communication with the controller 110.

The controller 110 also communicates with a customer 105 via a network such as the Internet (wired and/or wirelessly), via another network protocol, or via other means for communication as would be understood by those of ordinary skill in the art. Although only one customer 105 is depicted in FIG. 1A, any number of customers may be in communication with the controller 110.

The customer 105 and/or retailer 115 may comprise computers, such as those based on the Intel® Pentium® processor, that are adapted to communicate with the controller 110.

Communication with the controller 110 may be direct or indirect. For example, communication may be via the Internet through a Web site maintained by controller 110 on a remote server or via an on-line data network including commercial on-line service providers, bulletin board systems and the like. In some embodiments, the customer 105 and retailer 115 may communicate with controller 110 over radio frequency (“RF’), infrared (“IR”), cable TV, satellite links and the like, including combinations thereof.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

The controller 110 may function as a “Web server” that generates Web pages (documents on the Web that typically include an HTML file and associated graphics and script files) that may be accessed via the Web and allows communication with the controller 110 in a manner known in the art. Those of skill in the art will understand that there are a variety of well-known ways for creating and operating Web pages, and accordingly a detailed description of such known processes is omitted here for clarity.

Any or all of the customer 105, the controller 110 and retailer 115 may comprise, e.g., a conventional personal computer, a portable type of computer, such as a laptop computer, a palm-top computer, a hand-held computer, or a Personal Digital Assistant (PDA), or combinations thereof.

Referring to FIG. 1B, an apparatus 130 according to an embodiment of the present invention includes a controller 140 that is in communication with one or more customer terminals 135, one or more manufacturers 142, one or more sponsors 145, and one or more credit card clearing houses 152. Communication with each may be via a network such as the Internet (wired and/or wirelessly), via another network protocol, or via other means for communication as would be understood by those of ordinary skill in the art. It is also possible that controller 140 will receive information directly or indirectly from a POS terminal 150, such as a cash register (e.g., mechanical or electronic). The POS terminal may include a bar code scanner, keypad, and/or any other input device for receiving information related to one or more products being acquired. The POS terminal may also comprise or include means for receiving the previously assigned redemption code, along with information related to the specific products having been taken delivery of (e.g. coded information such as bar codes, SKUs or other product descriptor(s)).

A customer 105 communicates with the customer terminal 135, which may include a web browser or other known user interface means. The customer 105 also communicates with the POS terminal 150. In typical situations, the customer 105 will not communicate with the customer terminal 135 and the POS terminal 150 simultaneously.

As is known in the art, the credit card clearinghouse 152 communicates with one or more banks 155 as well as with the one or more POS terminals 150 to effectuate the processing of transactions made using a credit card account. For example, the credit card clearinghouse 152 may receive from the POS terminal a request to authorize a purchase for which a credit card account is to be charged for payment. The credit card clearinghouse 152 in turn responds to the request, typically to either authorize or deny the request. Via communication with the credit card clearinghouse 152, the controller 140 may likewise effectuate processing of credit card transactions via its communication with the credit card clearinghouse 152.

The manufacturers 142 can communicate with the controller 140 to, e.g., communicate desired prices, promotions and other product and pricing information to controller. It will be understood by those of ordinary skill in the art that, in addition to manufacturers, other product suppliers or sellers such as retailers, wholesalers and the like may communicate in a like manner with the controller 140.

The sponsors 145 include merchants willing to provide a benefit to the controller, manufacturer, customer, retailer and/or other parties in exchange for, e.g., advertising to the customer, acquisition of the customer as a client of the sponsor, other interaction with the customer.

Referring to FIG. 1C, an apparatus 160 according to an embodiment of the present invention includes a controller 165 that is in communication with one or more customer terminals 135, one or more manufacturers 142, one or more sponsors 145, and one or more credit card clearing houses 152. Communication with each may be via a network such as the Internet (wired and/or wirelessly), via another network protocol, or via other means for communication as would be understood by those of ordinary skill in the art.

It is also possible that controller 165 will receive information directly or indirectly from a POS terminal 170, via a POS peripheral 175 and a peripheral server 180. The POS terminal 170 may be a cash register (e.g., mechanical or electronic). The POS peripheral 175 may be a device that receives information from the POS terminal 170, such as a coupon printer of the type manufactured by Catalina Marketing Corporation. The peripheral server 180 may be in communication with a plurality of such POS peripherals, thereby allowing the peripheral server 180 to receive information regarding a plurality of transactions at a plurality of retailers.

The POS peripheral 175 may be operable to access a database (e.g., of peripheral server 180) to issue custom coupons, offers, incentives and messages based upon the transaction. The peripheral server 180 may thus monitor shopper purchase history over time by associating purchase behavior with customer identifiers, such as loyalty card or check cashing card numbers. Further, this information may be analyzed, e.g., to identify those customers which a particular retailer should find most desirable. Based upon retailer objectives, the peripheral server 180 may direct the appropriate POS peripheral 175 to issue customized messages to specific shoppers that are relevant to their shopping behaviors.

Information received by the POS peripheral 175 from the POS terminal 170 may include transaction data such as products purchased, prices of products purchased, coupons redeemed, and time and date of transaction.

A customer 105 communicates with the customer terminal 135, which may include a web browser or other known user interface means. The customer 105 also communicates with the POS terminal 170. In typical situations, the customer 105 will not communicate with the customer terminal 135 and the POS terminal 150 simultaneously.

As is known in the art, the credit card clearinghouse 152 communicates with one or more banks 155 as well as with the one or more POS terminals 150 to effectuate the processing of transactions made using a credit card account. For example, the credit card clearinghouse 152 may receive from the POS terminal a request to authorize a purchase for which a credit card account is to be charged for payment. The credit card clearinghouse 152 in turn responds to the request, typically to either authorize or deny the request. Via communication with the credit card clearinghouse 152, the controller 165 may likewise effectuate processing of credit card transactions via its communication with the credit card clearinghouse 152.

The manufacturers 142 can communicate with the controller 165 to, e.g., communicate desired prices, promotions and other product and pricing information to controller. It will be understood by those of ordinary skill in the art that, in addition to manufacturers, other product suppliers or sellers such as retailers, wholesalers and the like may communicate in a like manner with the controller 165.

The sponsors 145 include merchants willing to provide a benefit to the controller, manufacturer, customer, retailer and/or other parties in exchange for, e.g., advertising to the customer, acquisition of the customer as a client of the sponsor, other interaction with the customer.

In addition to the description above, other means for the controller to receive information regarding a set of products for which a buyer price is established online, and a corresponding set of products picked up at the retailer.

### DEVICES

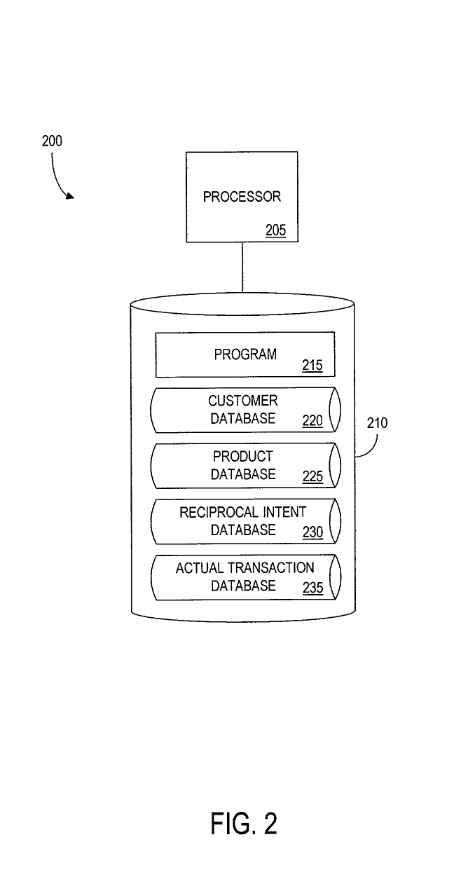

FIG. 2 illustrates an embodiment 200 of a controller. The controller may be implemented as a system controller, a dedicated hardware circuit, an appropriately programmed general purpose computer, or any other equivalent electronic, mechanical or electromechanical device.

The controller 200 comprises a processor 205, such as one or more Intel® Pentium® processors. As is well known in the art, the processor 205 may be in communication with a communication port (not shown in FIG. 2) or other means for facilitating communication between the processor 205 and other devices.

The processor 205 is also in communication with a data storage device 210. The data storage device 210 comprises an appropriate combination of magnetic, optical and/or semiconductor memory, and may include, for example, Random Access Memory (RAM), Read-Only Memory (ROM), a compact disc and/or a hard disk. The processor 205 and the storage device 210 may each be, for example: (i) located entirely within a single computer or other computing device; or (ii) connected to each other by a remote communication medium, such as a serial port cable, telephone line or radio frequency transceiver or other wired or wireless media. In one embodiment, the controller may comprise one or more computers that are connected to a remote server computer for maintaining databases.

The data storage device 210 stores a program 215 for controlling the processor 205. The processor 205 performs instructions of the program 215, and thereby operates in accordance with the embodiments of the present invention, and particularly in accordance with the methods described in detail herein. The program 215 may be stored in a compressed, uncompiled and/or encrypted format. The program 215 furthermore includes program elements that may be necessary, such as an operating system, a database management system and “device drivers” for allowing the processor 205 to interface with computer peripheral devices. Appropriate program elements are well known to those of ordinary skill in the art, and need not be described in detail herein.

According to an embodiment of the present invention, the instructions of the program 215 may be read into a main memory from another computer-readable medium, such from a ROM to RAM. Execution of sequences of the instructions in program 215 causes processor 205 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

The storage device 210 also stores (i) a customer database 220, (ii) a product database 225, (iii) a proposed transaction database 230, (iv) an actual transaction database 235 and (v) a promotional offer database 240. The databases are described in detail below and depicted with exemplary entries in the accompanying figures. As will be understood by those skilled in the art, the schematic illustrations and accompanying descriptions of the databases presented herein are exemplary arrangements for stored representations of information. Many other arrangements may be employed besides those suggested by the tables shown. Similarly, the illustrated entries of the databases represent exemplary information only; those skilled in the art will understand that the number and content of the entries can be different from those illustrated herein.

### DATABASES

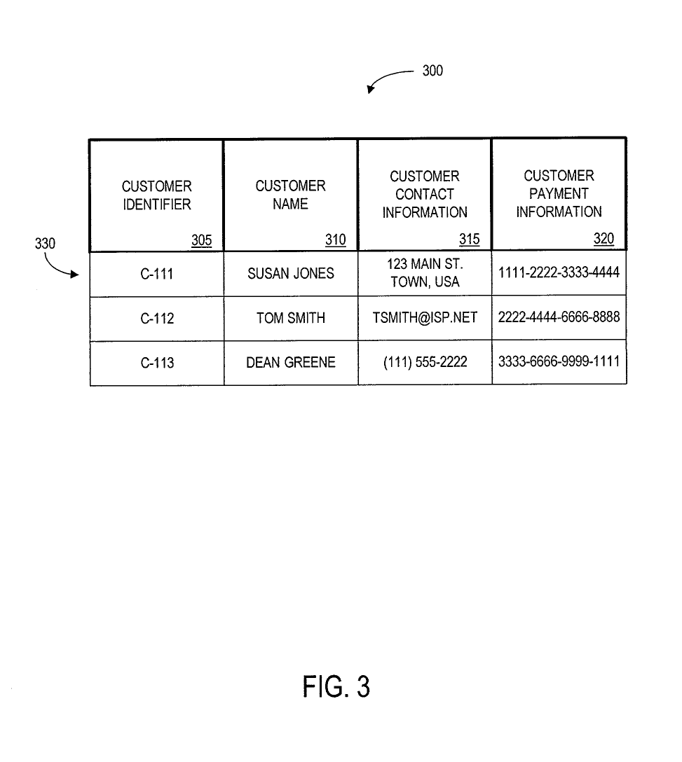

FIG. 3 is a tabular representation of an embodiment 300 of the customer database. The tabular representation of the customer database includes a number of example records or entries, including the entry 330, each of which defines a customer. Those skilled in the art will understand that the customer database may include any number of entries. The tabular representation of customer database also defines fields for each of the entries or records. The fields specify: (i) a customer identifier 305 that uniquely identifies the customer; (ii) a customer name 310; (iii) contact information 315 of the customer; and (iv) payment information 320 of the customer, such as credit card or debit card account information which may be used to render payment on behalf of the customer.

The customer identifier, as well as other identifiers described herein, may be generated or assigned by the controller, or may be established by the customer and provided to the controller by way of a customer terminal or other appropriate device. For example, the customer identifier may comprise a numeric code that is assigned to the corresponding customer by the controller. Alternatively, the customer identifier may comprise a user name and / or password that may be generated by a customer terminal and subsequently provided to the controller.

The data stored in the contact information field may comprise any of (i) an electronic mail (e-mail) address, (ii) a postal address, (iii) telephone number, and (iv) a numeric IP address of the customer.

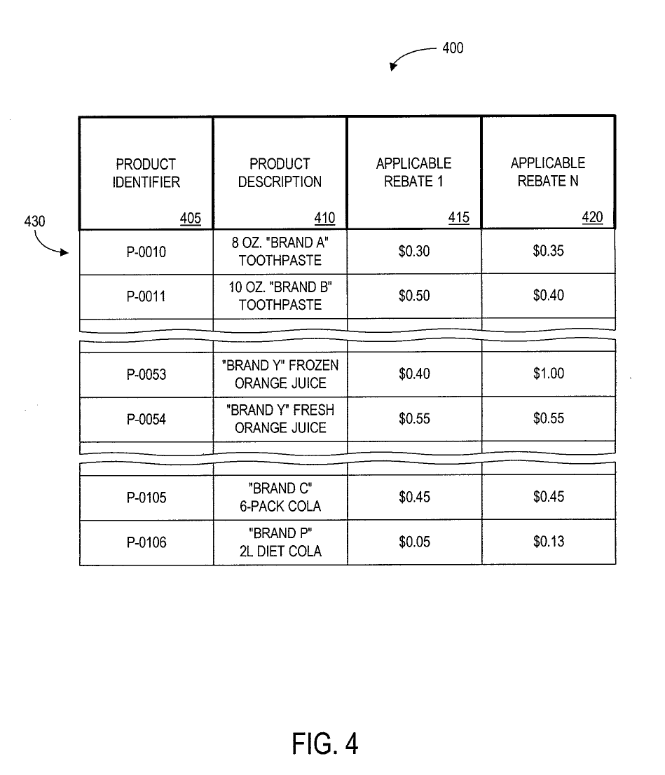

FIG. 4 is a tabular representation of an embodiment 400 of the product database. The tabular representation of the product database includes a number of example records or entries, including the entry 430, each of which defines a product offered for sale. Those skilled in the art will understand that the product database may include any number of entries, and that the information stored thereby may be specific to particular retailers. For example, the entry 430 may indicate a product offered for sale by, e.g., only a certain chain of stores, but not by others. Accordingly, the entries may optionally be associated with a retailer or set of retailers.

The tabular representation of product database also defines fields for each of the entries or records. The fields specify: (i) a product identifier 405 that uniquely identifies the product, such as an SKU or other appropriate identifier; (ii) a product description 410; and (iii) applicable rebates 415 and 420. Although two applicable rebates are illustrated in FIG. 4, any number of rebates may be used, and the number of rebates may differ among products in any manner desired.

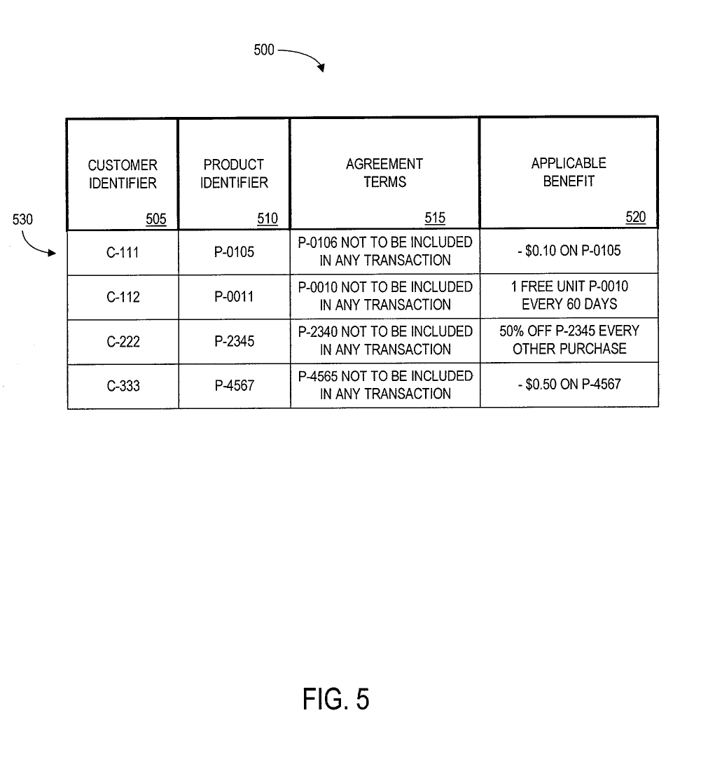

FIG. 5 is a tabular representation of an embodiment 500 of the reciprocal intent database. The tabular representation of the reciprocal intent database includes a number of example records or entries, including the entry 530, each of which defines an agreement by a customer to purchase, or not to purchase, one or more products or types/categories of products. Those skilled in the art will understand that the proposed reciprocal intent may include any number of entries.

The tabular representation of reciprocal intent database also defines fields for each of the entries or records. The fields specify: (i) a customer identifier 505 that uniquely identifies the customer; (ii) a product identifier 510 that identifies the product agreed to purchase; (iii) one or more agreement terms 515 which the customer agrees to, and which typically indicate products or types of products not to purchase; and (iv) applicable benefits 520 which the customer receives in exchange for the agreement.

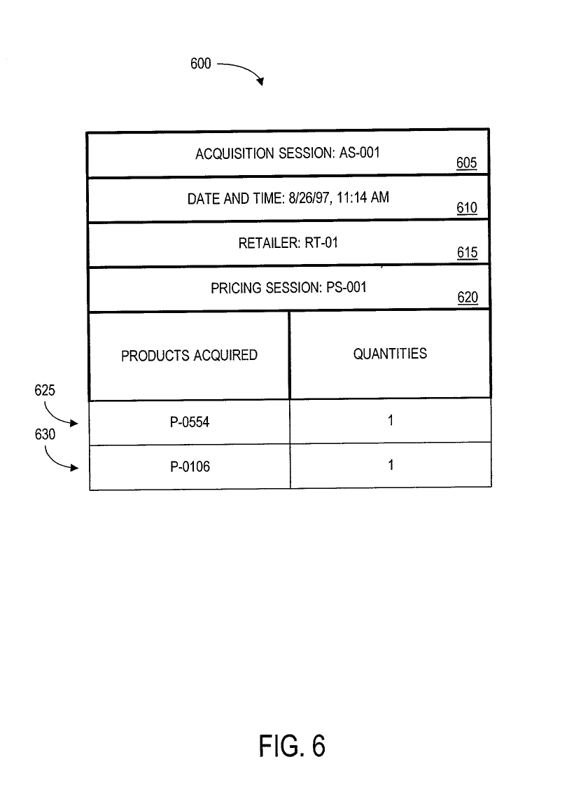

FIG. 6 is a tabular representation of a record 600of an embodiment of the actual transaction database. The actual transaction database would typically contain a plurality of such records, each such record defining an actual transaction of a customer with a retailer. The tabular representation of the record 600 includes a number of example records or entries, including the entries 625 and 630, each of which defines a product and corresponding quantity acquired during the transaction. Those skilled in the art will understand that the record may include any number of entries. The tabular representation of customer database also defines fields for each of the entries or records.

The record further specifies: (i) an acquisition session identifier 605 that uniquely identifies the actual transaction; (ii) a date and time 610 of the transaction; (iii) a retailer 615 with which the transaction occurred; and (iv) a pricing session 620 which indicates the proposed transaction that the actual transaction was purported to correspond to.

### PROCESS DESCRIPTION

In accordance with the present invention, the controller may determine a first plurality of products which a buyer has agreed to purchase in exchange for a rebate or other favorable treatment. The agreement may be to purchase the products for a buyer price that is lower than a retail price of the first plurality of products.

Thereafter, the controller determines a second plurality of products which the buyer has actually received, e.g., by receiving from a retailer the transaction log indicating transactions with the retailer.

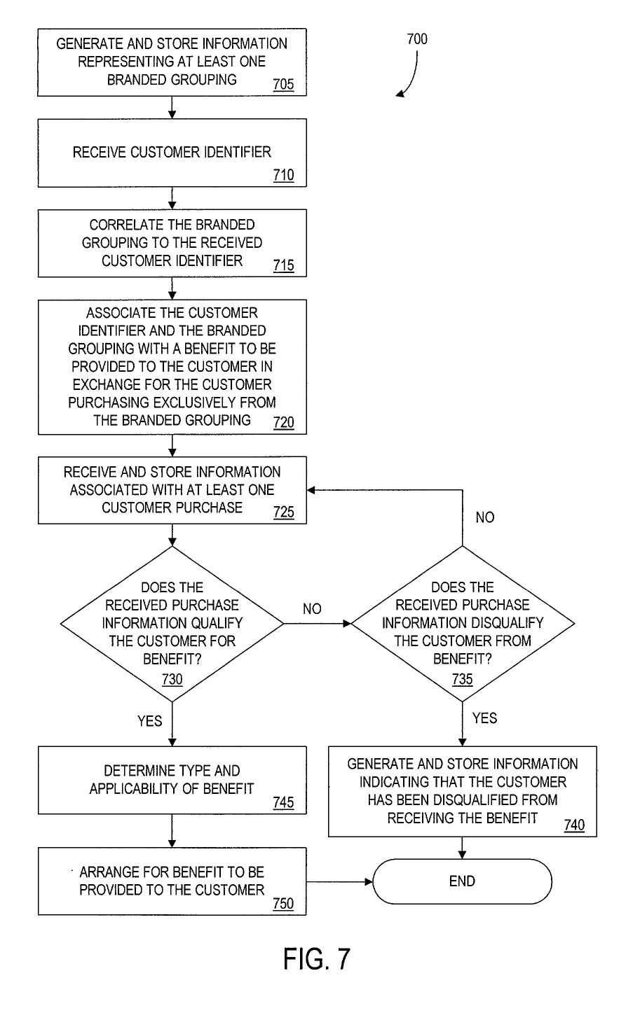

Referring to FIG. 7, at step 705 the controller generates and stores information representing at least one branded grouping. The controller also receives a customer identifier (step 710).

At step 715, the controller correlates the branded grouping to the received customer identifier, and at step 720 associates the customer identifier and the branded grouping with a benefit to be provided to the customer. The benefit is provided in exchange for the customer purchasing exclusively from the branded grouping.

At step 725, the controller receives and stores information associated with at least one customer benefit. If the received purchase information does not qualify the customer for benefit (step 730), the controller determines at step 735 whether the received purchase information disqualifies the customer from the benefit (e.g., purchasing a product agreed not to be purchased). If so, the controller generates and stores information indicating that the customer has been disqualified from receiving the benefit, (step 740).

If the received purchase information qualifies the customer for benefit (step 730), then the controller determines the type and applicability of benefit (step 745), and then arranges for benefit to be provided to the customer (step 750).

Although the present invention has been described with respect to a preferred embodiment thereof, those skilled in the art will note that various substitutions may be made to those embodiments described herein without departing from the spirit and scope of the present invention. For example, the applicable benefits for a customer may increase over time. In one embodiment, the longer a customer exclusively buys a product over time the greater the applicable benefit may be (or become).

What is claimed is:

1. A method comprising:
receiving from a customer an agreement to restrict purchases of at least one particular product;
receiving data representing purchases made by the customer;
verifying that the customer has complied with the agreement to restrict purchases of the at least one particular product; and
providing a benefit to the customer.

2. A method comprising:
receiving from a customer an agreement to not purchase a particular product;
receiving data representing purchases made by the customer;
verifying that the customer has not purchased the particular product; and
providing a benefit to the customer in response to the verifying.

3. The method of claim 2, in which the step of providing a benefit comprises:
not charging an amount to refund a previously awarded benefit.

4. The method of claim 2, further comprising:
receiving a transaction log representing a plurality of purchases made by the customer.

5. The method of claim 2, in which the benefit comprises:
providing the customer with a reduced price on a product.

6. The method of claim 5, in which the benefit comprises:
providing the customer with a reduced price on a product that is a substitute for the particular product.

7. The method of claim 2, further comprising:
warning the customer if the customer orders the particular product.

8. The method of claim 7, in which the step of warning comprises:
transmitting a warning message if the customer orders the particular product.

9. The method of claim 2, in which the benefit comprises:
providing the customer with a credit on a credit card account.
